(19) United States
(12) Patent Application Publication
(10) Pub. No.: US 2021/0336947 A1
(43) Pub. Date: Oct. 28, 2021

(54) ROGUE CERTIFICATE DETECTION

(71) Applicant: MICROSOFT TECHNOLOGY LICENSING, LLC, Redmond, WA (US)

(72) Inventor: Mor RUBIN, Ashdod (IL)

(21) Appl. No.: 16/859,970

(22) Filed: Apr. 27, 2020

(51) Int. Cl. H04L 29/06; H04L 9/32; G06F 9/54; G06N 20/00

(52) U.S. Cl. CPC H04L 63/0823; H04L 63/0807; H04L 63/102; G06N 20/00; H04L 9/3268; G06F 9/547; H04L 63/1425

(57) ABSTRACT

Unauthorized use of user credentials in a network implementing an authentication protocol is detected. Authentication certificates that are observed in the network are uniquely identified and monitored. A baseline profile of the authentication certificates is generated. For a new request to access a resource in the network, a unique identifier for the submitted authentication certificate is generated. If the identifier is new: the submitted authentication certificate is compared to the baseline profile and an alert is generated when the difference from the baseline profile exceeds a threshold. If the unique identifier for the submitted authentication certificate has previously been identified and is not included in the baseline profile, an alert is generated when the source computer associated with the unique identifier is not found in a chain of connection to the original source.

### BACKGROUND

Computer networks are under constant threat from malicious parties seeking unauthorized access to the systems hosted thereon. The tactics used by malicious parties to attack networks and the tactics used by network administrators to defend against attacks are constantly evolving as the tactics are updated. New exploits are added to the arsenal of malicious parties and ineffective exploits are dropped. Implementing countermeasures, however, is often reactive, wherein network administrators must wait to identify the newest exploit before deploying a countermeasure and determining when to stop deploying a countermeasure when the corresponding exploit is no longer used. Correctly anticipating, identifying, and blocking the new exploits is crucial to maintaining security of a network.

It is with respect to these considerations and others that the disclosure made herein is presented.

### SUMMARY

The disclosed embodiments describe technologies for protecting computing systems from an attack vector in which an attacker accesses a certificate with a private key and uses the certificate to gain unauthorized access to resources even when the password is changed. Various embodiments are disclosed for detecting the use of a certificate from previously unrecognized sources. This may allow networks and data centers to provide improved security, more effectively adhere to operational objectives, and improve operating efficiencies.

In one embodiment, functionality may be added to domain controllers in a network that uses an authentication protocol such as Kerberos. The functionality may be added as an application or agent (referred to herein as the “detection application”) running on the domain controllers. The detection application may be configured to parse a Kerberos Authentication Server (AS) request (the request that contains the certificate) and hash the certificate to generate a unique identifier for the certificate.

The detection application may then track and learn the uses of certificate's unique identifier from the computers in the domain. The learned behavior may be used to generate a dictionary of unique certificate identifiers and the computers that are using the certificates.

The detection application may further learn the following properties of each certificate per certificate authority, such as the signature algorithm, the signature hash algorithm, the time period during which the certificate is valid, the public key size, the subject format, and the certificate templates. The detection application may parse Kerberos ticket-granting service (TGS) requests (the request contains the resource and protocol) and store data indicative of usage of remote desktop connections for the requested computer to the desired computer. In one example, the remote desktop connections may use the TERMSRV protocol.

After a learning period, the detection application may determine a certificate unique identifier and perform the following:

If the certificate unique identifier is new:
If the certificate properties are different from previously observed properties, the certificate unique identifier is flagged and an alert is generated.
If the certificate properties are not different from previously observed properties, the identifier is added to the dictionary and the detection application continues monitoring the network.

If the certificate unique identifier is known:
If the source computer associated with the identifier is in the dictionary, the detection application continues monitoring the network.
If the source computer associated with the identifier is not in the dictionary, the detection application checks if there is any chain of remote desktop connections that leads to the source computer associated with the identifier.
   a. If a chain of remote desktop connections is found that leads to the source computer associated with the identifier, the detection application continues monitoring the network;
   b. If a chain of remote desktop connections that leads to the source computer associated with the identifier is not found, an alert is generated.

By providing such a mechanism for identifying the potential misuse of a certificate, loss of data and services may be avoided or mitigated, reducing downtime and impact to end users and providing for improved security and operational efficiency for computing networks and service providers.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1 is a diagram illustrating an example system implementing an authentication protocol in accordance with the present disclosure;

FIG. 2 is a diagram illustrating an example system implementing an authentication protocol in accordance with the present disclosure;

FIG. 3 is a diagram illustrating a data center in accordance with the present disclosure;

FIG. 4 is a flowchart depicting an example procedure for detecting unauthorized use of user credentials in a network implementing an authentication protocol in accordance with the present disclosure;

FIG. 5 is a flowchart depicting an example procedure for detecting unauthorized use of user credentials in a network implementing an authentication protocol in accordance with the present disclosure;

FIG. 6 is an example computing device in accordance with the present disclosure.

### DETAILED DESCRIPTION

Two widely used approaches for providing authentication in a computing environment include Kerberos and NT (New Technology) LAN Manager (NTLM). NTLM is a protocol used by one machine to authenticate itself to another machine. A domain controller validates the user and the provided password. Kerberos is an authentication protocol where every user who wishes to access a resource or perform any login must provide authentication to the domain controller and obtain a ticket that verifies a user's identity. After obtaining this proof of identity, requests for access to resources are provided to the domain controller which processes the request and provides additional tickets to access the desired resources.

Although Kerberos authentication protects the user password on the domain controller, the password remains unprotected on the user endpoint and may be guessable. A number of attacks are known to attempt to gain the user secret and impersonate the user, including “Pass The Hash,” “Over Pass The Hash,” and “Pass The Ticket.”

The Kerberos protocol provides an extension that allows users to authenticate with a certificate instead of a password. This mechanism makes it more difficult to guess and steal a password as every certificate uses a private key which is more difficult to guess than a password or a hash. Every user in an organization can request a certificate for sign-in as long that there is a Certificate Authority server in the organization which is trusted by the domain controller. The certificate private key remains the same even if the user changes their password. Furthermore, a certificate remains valid if it is not revoked or until after its valid time frame has been exceeded. It is thus important to detect and mitigate the unauthorized access and use of certificates (also referred to as “tickets”).

The following Detailed Description describes technologies for protecting user credentials by detecting a new attack vector in which an attacker accesses a user's authentication certificate with its associated private key and uses the certificate to gain unauthorized access from a remote location, even when the user changes the password. Techniques are described to detect the use of the unauthorized certificate by detecting uses from sources that are unrecognized.

As used herein, a domain may be defined as an administrative unit corresponding to a security boundary. Computers in a domain may share physical proximity on a local area network (LAN) or may be located in different geographic parts of the world and communicate over various types of physical connections, including ISDN, fiber, Ethernet, Token Ring, frame relay, satellite, and leased lines, etc. Domain administrators typically create one user account for each user within a domain and the users log on to the domain rather than repeatedly logging on to various individual resources in the domain. In addition, a domain controller may control various aspects of the domain such as individual use of resources on the domain. The users may access resources in the domain subject to user rights, privileges and system-wide policies. There may be predefined (built-in) user groups with sets of assigned user rights and domain administrators may assign user rights by adding a user account to one of the predefined user groups or by creating a new group and assigning specific user rights to that user group. Users who are subsequently added to a user group may automatically gain all user rights assigned to that user group.

In an embodiment, an agent or application (referred to herein as “detection application”) may be installed on domain controllers in a domain or other grouping of computing resources. The detection application may be configured to parse network traffic, such as Kerberos traffic, and determine baseline profiles for the certificates and their usage. Based on the baseline profiles, the detection application may identify potential misuse of a certificate and generate an alert for responsive action.

In one embodiment, the detection application may be configured to parse a Kerberos Authentication Server (AS) request (the request that contains the certificate) and hash the certificate to generate a unique identifier for the certificate. The detection application may track and learn the uses of the certificate's unique identifier based on the observed behavior of the computers in the domain. The learned behavior may be used to generate a dictionary of certificate unique identifiers and the computers that are using the certificates.

The detection application may further learn the following properties of each certificate per certificate authority:
The signature algorithm
The signature hash algorithm
The time period during which the certificate is valid (valid to property—valid from property)
The public key size
The subject format
The certificate templates

The detection application may parse Kerberos ticket-granting service (TGS) requests (the request contains the resource and protocol) and store data indicative of usage of remote desktop connections for the requested computer to the desired computer. In one example, the remote desktop connections may use the TERMSRV protocol.

The detection application may receive and track information pertaining to use of certificates from various sources in the domain. For example, the number of uses of certificates and the source of the requests may be tracked during a time window. After the learning period, the detection application may determine a certificate unique identifier and perform the following:

If the certificate unique identifier is new:
If the certificate properties are different from previously observed properties, the certificate unique identifier is flagged and an alert is generated
If the certificate properties are not different from previously observed properties, the identifier is added to the dictionary and the detection application continues monitoring the network

If the certificate unique identifier is known:
If the source computer associated with the identifier is in the dictionary, the detection application continues monitoring the network
If the source computer associated with the identifier is not in the dictionary, the detection application checks if there is any chain of remote desktop connections that leads to the source computer associated with the identifier.
   a. If a chain of remote desktop connections is found that leads to the source computer associated with the identifier, the detection application continues monitoring the network;
   b. If a chain of remote desktop connections that leads to the source computer associated with the identifier is not found, an alert is generated.

In some embodiments, the detection application may exclude some certificates from generating alerts when the certificates are used for interactive logins. For example, interactive login attempts may be detected from Windows event 4624 with logon type 2 in the Windows context, or from a Kerberos TGS request that is sent to the service “HOST.”

In one embodiment, the primary information that is tracked is information pertaining to the source computer. In other embodiments, the primary information may be augmented with supplementary information such as the resources that are being accessed, the frequency of access, and other factors.

The described techniques may be used to detect and identify unauthorized certificate usage by collecting data and learning baseline or normal usage activity and properties for each certificate that is used in a domain. Since each valid certificate can be used by other machines in the domain, the described techniques may minimize false positives for valid operations and activities associated with remote desktop connections.

The described techniques may further be used to detect the usage of unauthorized certificates from a plurality of operating systems. Furthermore, the described techniques may be used to detect unauthorized use of a plurality of certificate types, including Windows Hello for Business, certificate generated by an authority, physical smartcards, virtual smartcards, and the like.

In some embodiments, the detection application may be installed on computers that are able to listen to Cryptographic Application Programming Interface (CryptoAPI) calls or similar APIs. Such APIs may be configured to provide various public-key and symmetric key based authentication using digital certificates. When a call is made to export a certificate, the detection application may output a log of all of the certificate unique identifiers on the computer. This log may be correlated with the techniques described above to include certificate unique identifiers that are already being exported and that may be used as unauthorized certificates.

Characteristic profiles may be generated to determine a profile associated with one or more credentials such as a certificate. The profile may be determined based on statistical information, which may include any combination of histograms of requesting computers, confidence scores, variance metrics, central tendency values, probability distribution functions, and the like. The profile may also be determined based on time-distributed data.

In some embodiments, a machine learning model may be implemented to detect unauthorized use of credentials. In some configurations, the machine learning model may be configured to utilize supervised, unsupervised, or reinforcement learning techniques to generate correlations. For example, the machine learning model may utilize supervised machine learning techniques by training on the collected credential data. In some embodiments, the machine learning model may also, or alternatively, utilize unsupervised machine learning techniques to determine correlations including, but not limited to, a clustering-based model, a forecasting-based model, a smoothing-based model, or another type of unsupervised machine learning model. In some embodiments, the machine learning model may also, or alternately, utilize reinforcement learning techniques to generate results. For example, the model may be trained using the input data and, based on feedback, the model may be rewarded based on its output.

The time period during which the certificate usage behaviors are learned and a baseline profile is determined may be determined based on a time threshold or when the baseline profile is stabilized.

Referring to the appended drawings, in which like numerals represent like elements throughout the several FIGURES, aspects of various technologies for detecting unauthorized certificates will be described. In the following detailed description, references are made to the accompanying drawings that form a part hereof, and which are shown by way of illustration specific configurations or examples.

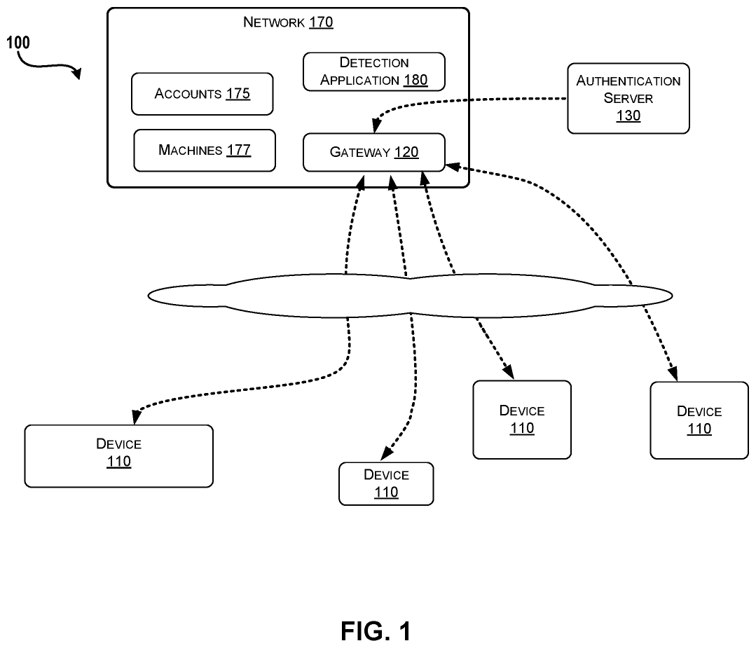

FIG. 1 illustrates an example environment 100 in which authorization requests are handled by a system from various requesting devices. As illustrated, one or more devices 110 that are seeking authorization may attempt to gain access to accounts 175 or physical/virtual machines 177 hosted within the network 170. The devices 110 may connect to the network 170 via a gateway 120 which is in communication with the authentication server 130.

The authentication server 130 may be configured to handle the authorization or rejection of login attempts carried in authentication traffic. Although not illustrated, one of skill in the art will appreciate that various servers and intermediaries in a distributed network may be implemented between the devices 110 and the gateway 120 to route a message between the user and the network 170. As will also be appreciated, although some components of the example environment 100 are illustrated singly, in various aspects multiple copies of those components may be deployed, for example, for load balancing purposes, redundancy, or offering multiple services.

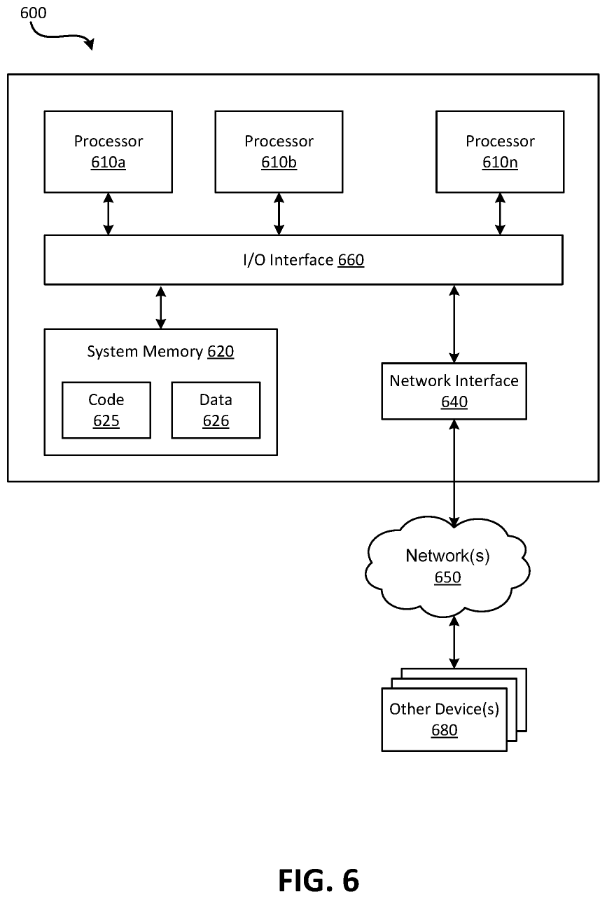

The devices 110 are illustrative of various computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, printers, and mainframe computers. The hardware of these computing systems is discussed in greater detail in regard to FIG. 6.

The devices 110 may be accessed locally and/or by a network, which may include the Internet, a Local Area Network (LAN), a private distributed network for an entity (e.g., a company, a university, a government agency), a wireless ad hoc network, a Virtual Private Network (VPN) or other direct data link (e.g., Bluetooth connection, a direct wired link). For example, a malicious party may attempt to obtain a certificate for accessing restricted resources which may be done without the knowledge or consent of the devices' owners. In another example, devices 110 may be the computing devices used by a legitimate user seeking to access an account which may make one or more attempts to access the account.

The gateway 120 may be a hardware device, such as a network switch, or a software service that links the devices 110 from the external network (e.g., the Internet) to the authentication server 130 over the network 170 (e.g., an intranet). In various aspects, the gateway device 120 may provide a firewall and may regulate the flow of communications traffic into and out of the local network 170. The gateway 120 may be configured to forward messages to the authentication server 130 from the devices 110 (as well as other devices on the internal network).

The authentication server 130 may receive authorization requests from the devices 110 and determine whether to grant access to accounts served by the network 170. The authentication server 130 may be a physical machine or a virtual machine that handles the authentication requests for the network 170 and acts as a domain controller. The authentication server 130 may use various authentication protocols including, but not limited to, PAP (Password Authentication Protocol), CHAP (Challenge-Handshake Authentication Protocol), EAP (Extensible Authentication Protocol), Kerberos, or an AAA (Authentication, Authorization, Accounting) architecture protocol, to allow a user access to one or more systems within a network 170. Depending on the standards used, the number of protected systems in the network 170 and user account settings, the successful presentation of authentication parameters will grant the devices 110 access to one or more systems safeguarded by the authentication server 130 and at an appropriate permissions level for the associated user.

In an embodiment, the authentication server 130 may execute a detection application 180 that is configured to access network traffic to monitor authentication traffic over the gateway 120 destined for the authentication server 130 to determine profiles for the credentials being used and determine whether any of the communications represent an unauthorized use of user credentials. In some embodiments, the detection application 180 may be executed on a separate device with unique MAC and IP addresses from the other devices in the network 170 and receive copies of messages that are forwarded to the authentication server 130 from the gateway 120 via the Remote Network Monitoring (RMON) or Switch Monitoring (SMON) specifications, port mirroring, or similar forwarding scheme. In other aspects, the detection application 180 may intercept all network traffic bound for the authentication server 130 (either with the same MAC and IP address or unique addresses) or passively taps and listens to the transmission medium on which the communications are sent to the authentication server 130. In yet other aspects, the detection application 180 may execute on a virtual machine or as a process on the authentication server 130 and may thereby passively share communications received at the application server 130.

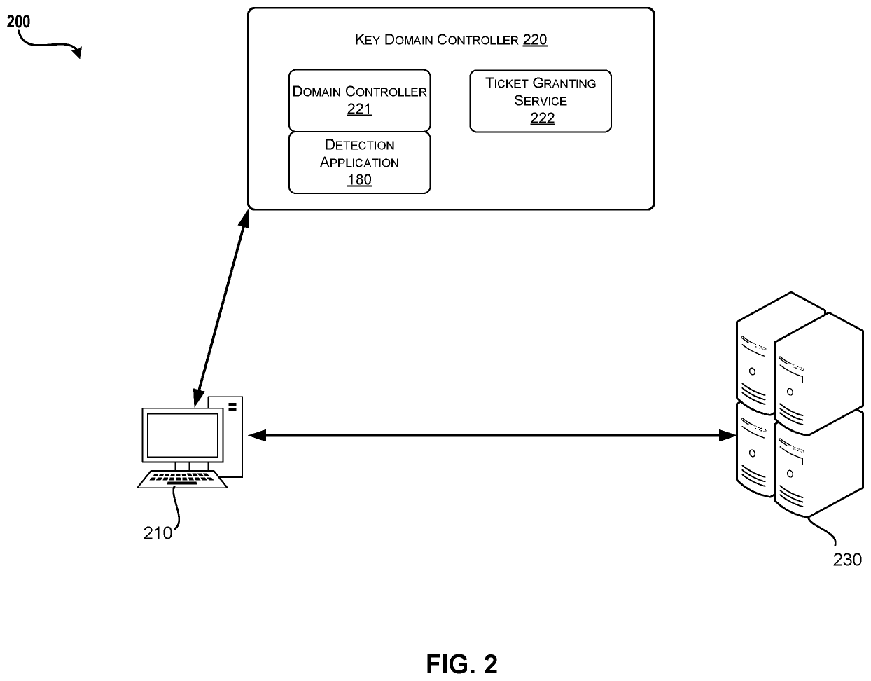

FIG. 2 illustrates an example authentication protocol system 200. Various authentication protocols may allow a Single Sign On (SSO) experience where users actively authenticate (i.e., provide a password) only once even though accessing multiple services or accessing a single service via different sessions (e.g., closing and reopening a program used to access the service), or may require reauthentication each time the user attempts to access the service.

The Kerberos protocol, for instance, allows an SSO experience, where a user supplies a domain name, account name, and a password to access a local computing device 210 and subsequently one or more network services 230 (e.g., an email service, a document management system, a virtual machine, and the like). The computing device 210 may authenticate the credentials supplied by the user with a Key Domain Controller 220 by sending a timestamp (of the current time of the authentication request) to the Key Domain Controller 220 that is encrypted with a key derived from the user's password. The Key Domain Controller 220 may verify the user's identity by decrypting the message with its copy of the user's password-derived key, stored on the authentication server 130, and by verifying that the timestamp is relevant (e.g., the unencrypted time is possible, given potential network latency, to match a time of a login request). If the timestamp is relevant, the Key Domain Controller 220 may transmit a Ticket Granting Ticket (TGT) to the computing device 210 which is an identifier that enables the computing device 210 to request access to network services 230 without having to re-supply the user's credentials (e.g., domain name, account name, password).

Once a TGT has been granted to the user on the computing device 210, and until the TGT expires, each time the computing device 210 attempts to access a network service 230, the computing device 210 may identify itself to a domain controller 221 (residing in the Key Domain Controller 220) with the TGT. The domain controller 221, through a ticket granting service 222, may provide the computing device with the access ticket for the particular network service 230 that the user is attempting to contact. The user may then, via the computing device 210, provide the access ticket to the network service 230. The network service 230, because the access ticket has been validated by the ticket granting service 222, may authorize the user's access, and a connection between the computing device 210 and the network service 230 may be established without the user needing to re-input credentials.

The NTLM (Networked LAN Management) Protocol is another authentication protocol which uses credentials of a domain name, an account name, and a password (or a one-way hash thereof) to enable logons via a challenge/response model. Instead of sending the user's password between the computing device 210 and the network service 230 for which access is sought, the computing device 210 must perform a calculation that proves it has access to the secured credentials.

Under NTLM version one (NTLMv1), the network service 230 authenticates the user by sending an eight-byte random number as a challenge to the computing device 210. The computing device 210 may perform an operation using this eight-byte random number and a hash of the user's password. In various aspects, the user may also initiate a challenge to the network service 230. The user may return a 24-byte result (and optionally its own challenge) to the network service 230 which may verify whether the client has computed the correct result and should therefore be granted access to the network service 230.

In greater detail, a response to a challenge under NTLMv1 is calculated by deriving a 16-byte key from the user's password (the hash) which may be done according to the LM hash algorithm or the NT hash algorithm and which is then padded with null values to reach 21-bytes in size. The padded hash may then broken into thirds (seven-bytes) which are used to create three keys for the Data Encryption Standard (DES) algorithm. Each of the keys may then be used to encrypt the challenge via DES (in electronic codebook mode) which results in three eight-byte cipher texts that are concatenated into the 24-byte response.

NTLM version two (NTLMv2) builds on NTLMv1 to provide additional security and strengthen NTLMv1 to employ a 128 bit key space wherein the term “key space” is understood to refer to the set of possible valid keys for a given encryption algorithm used by the protocol. NTLMv2 allows for the continued use of an existing domain controller from a previous NTLMv1 regime. NTLMv2 adds additional client challenges to a response which are hashed and transmitted to the network service 230 to grant or deny access to the user.

As will be appreciated, although the Kerberos and NTLM protocols were discussed in detail in regard to FIG. 2, other authentication protocols may be used, or variations to the presented protocols may be made. The protocols discussed in FIG. 2 are given as non-limiting examples to introduce the operations and terminologies involved in example aspects for detecting unauthorized use of credentials within the present disclosure. Other protocols using various encryption algorithms may be used without departing from the spirit and scope of the present disclosure.

FIG. 2 further illustrates that detection application 180 may run on domain controller 221 or in another computing environment that is able to access information as described above. Detection application 180 may be configured to access network traffic to monitor authentication traffic to determine profiles for the credentials being used and determine whether any of the communications represent an unauthorized use of user credentials as described herein.

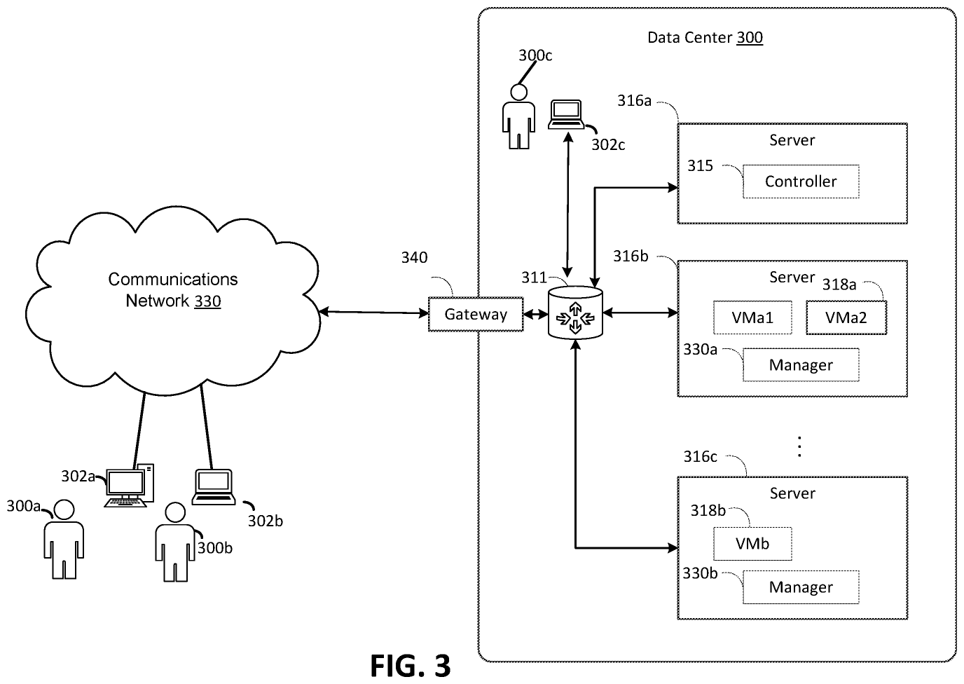

FIG. 3 illustrates an example computing environment in which the embodiments described herein may be implemented. FIG. 3 illustrates a data center 300 that is configured to provide computing resources to users 300a, 300b, or 300c (which may be referred herein singularly as “a user 300” or in the plural as “the users 300”) via user computers 302a,302b, and 302c (which may be referred herein singularly as “a computer 302” or in the plural as “the computers 302”) via a communications network 330. The computing resources provided by the data center 300 may include various types of resources, such as computing resources, data storage resources, data communication resources, and the like. Each type of computing resource may be general-purpose or may be available in a number of specific configurations. For example, computing resources may be available as virtual machines. The virtual machines may be configured to execute applications, including Web servers, application servers, media servers, database servers, and the like. Data storage resources may include file storage devices, block storage devices, and the like. Each type or configuration of computing resource may be available in different configurations, such as the number of processors, and size of memory and/or storage capacity. The resources may in some embodiments be offered to clients in units referred to as instances, such as virtual machine instances or storage instances. A virtual computing instance may be referred to as a virtual machine and may, for example, comprise one or more servers with a specified computational capacity (which may be specified by indicating the type and number of CPUs, the main memory size and so on) and a specified software stack (e.g., a particular version of an operating system, which may in turn run on top of a hypervisor).

Data center 300 may include servers 316a, 316b, and 316c (which may be referred to herein singularly as “a server 316” or in the plural as “the servers 316”) that provide computing resources available as virtual machines 318a and 318b (which may be referred to herein singularly as “a virtual machine 318” or in the plural as “the virtual machines 318”). The virtual machines 318 may be configured to execute applications such as Web servers, application servers, media servers, database servers, and the like. Other resources that may be provided include data storage resources (not shown on FIG. 3) and may include file storage devices, block storage devices, and the like. Servers 316 may also execute functions that manage and control allocation of resources in the data center, such as a controller 315. Controller 315 may be a fabric controller or another type of program configured to manage the allocation of virtual machines on servers 316.

Referring to FIG. 3, communications network 330 may, for example, be a publicly accessible network of linked networks and may be operated by various entities, such as the Internet. In other embodiments, communications network 330 may be a private network, such as a corporate network that is wholly or partially inaccessible to the public.

Communications network 330 may provide access to computers 302. Computers 302 may be computers utilized by users 300. Computer 302a,302b or 302c may be a server, a desktop or laptop personal computer, a tablet computer, a smartphone, a set-top box, or any other computing device capable of accessing data center 300. User computer 302a or 302b may connect directly to the Internet (e.g., via a cable modem). User computer 302c may be internal to the data center 300 and may connect directly to the resources in the data center 300 via internal networks. Although only three user computers 302a,302b, and 302c are depicted, it should be appreciated that there may be multiple user computers.

Computers 302 may also be utilized to configure aspects of the computing resources provided by data center 300. For example, data center 300 may provide a Web interface through which aspects of its operation may be configured through the use of a Web browser application program executing on user computer 302. Alternatively, a stand-alone application program executing on user computer 302 may be used to access an application programming interface (API) exposed by data center 300 for performing the configuration operations.

Servers 316 may be configured to provide the computing resources described above. One or more of the servers 316 may be configured to execute a manager 320a or 320b (which may be referred herein singularly as “a manager 320” or in the plural as “the managers 320”) configured to execute the virtual machines. The managers 320 may be a virtual machine monitor (VMM), fabric controller, or another type of program configured to enable the execution of virtual machines 318 on servers 316, for example.

It should be appreciated that although the embodiments disclosed above are discussed in the context of virtual machines, other types of implementations can be utilized with the concepts and technologies disclosed herein.

In the example data center 300 shown in FIG. 3, a network device 311 may be utilized to interconnect the servers 316a and 316b. Network device 311 may comprise one or more switches, routers, or other network devices. Network device 311 may also be connected to gateway 340, which is connected to communications network 330. Network device 311 may facilitate communications within networks in data center 300, for example, by forwarding packets or other data communications as appropriate based on characteristics of such communications (e.g., header information including source and/or destination addresses, protocol identifiers, etc.) and/or the characteristics of the private network (e.g., routes based on network topology, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

It should be appreciated that the network topology illustrated in FIG. 3 has been greatly simplified and that many more networks and networking devices may be utilized to interconnect the various computing systems disclosed herein. These network topologies and devices should be apparent to those skilled in the art.

It should also be appreciated that data center 300 described in FIG. 3 is merely illustrative and that other implementations might be utilized. Additionally, it should be appreciated that the functionality disclosed herein might be implemented in software, hardware or a combination of software and hardware. Other implementations should be apparent to those skilled in the art. It should also be appreciated that a server, gateway, or other computing device may comprise any combination of hardware or software that can interact and perform the described types of functionality, including without limitation desktop or other computers, database servers, network storage devices and other network devices, PDAs, tablets, smartphone, Internet appliances, television-based systems (e.g., using set top boxes and/or personal/digital video recorders), and various other consumer products that include appropriate communication capabilities. In addition, the functionality provided by the illustrated modules may in some embodiments be combined in fewer modules or distributed in additional modules. Similarly, in some embodiments the functionality of some of the illustrated modules may not be provided and/or other additional functionality may be available.

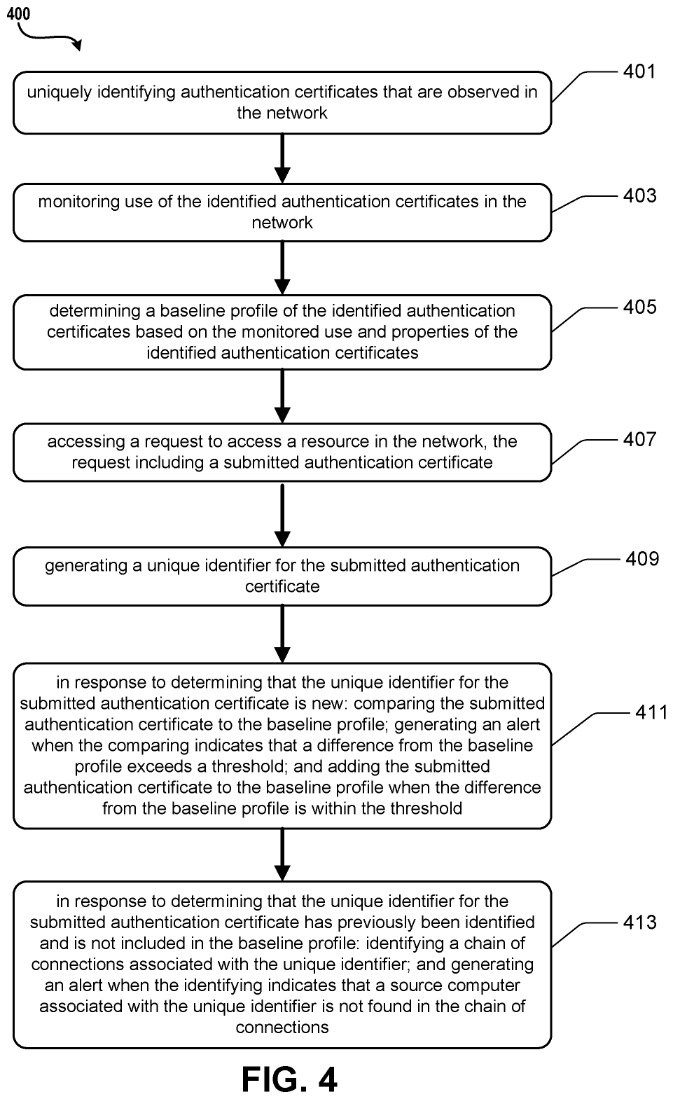

Turning now to FIG. 4, illustrated is an example operational procedure for detecting unauthorized use of credentials in accordance with the present disclosure. The operational procedure may be implemented in a system comprising one or more computing devices.

It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Although the example routine described below is operating on a computing device, it can be appreciated that this routine can be performed on any computing system which may include a number of computers working in concert to perform the operations disclosed herein.

Thus, it should be appreciated that the logical operations described herein are implemented (1) as a sequence of computer implemented acts or program modules running on a computing system such as those described herein and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

Referring to FIG. 4, operation 401 illustrates uniquely identifying authentication certificates that are observed in the network.

Operation 401 may be followed by operation 403. Operation 403 illustrates monitoring use of the identified authentication certificates in the network.

Operation 403 may be followed by operation 405. Operation 405 illustrates determining a baseline profile of the identified authentication certificates based on the monitored use and properties of the identified authentication certificates.

Operation 405 may be followed by operation 407. Operation 407 illustrates accessing a request to access a resource in the network, the request including a submitted authentication certificate.

Operation 407 may be followed by operation 409. Operation 409 illustrates generating a unique identifier for the submitted authentication certificate.

Operation 409 may be followed by operation 411. Operation 411 illustrates in response to determining that the unique identifier for the submitted authentication certificate is new, comparing the submitted authentication certificate to the baseline profile, generating an alert when the comparing indicates that a difference from the baseline profile exceeds a threshold, and adding the submitted authentication certificate to the baseline profile when the difference from the baseline profile is within the threshold.

Operation 409 may be followed by operation 411. Operation 411 illustrates in response to determining that the unique identifier for the submitted authentication certificate is new, comparing the submitted authentication certificate to the baseline profile, generating an alert when the comparing indicates that a difference from the baseline profile exceeds a threshold, and adding the submitted authentication certificate to the baseline profile when the difference from the baseline profile is within the threshold.

Operation 411 may be followed by operation 413. Operation 413 illustrates in response to determining that the unique identifier for the submitted authentication certificate has previously been identified and is not included in the baseline profile, identifying a chain of connections associated with the unique identifier, and generating an alert when the identifying indicates that a source computer associated with the unique identifier is not found in the chain of connections.

In an embodiment, the method is performed by an application or agent running in a domain controller of the network.

In an embodiment, the unique identifiers are generated based on a hash of the certificates.

In an embodiment, the properties comprise one or more of a signature algorithm, a signature hash algorithm, a time period during which the certificate is valid, a public key size, a subject format, and certificate templates.

In an embodiment, the method further comprises continuing to monitor the network when the unique identifier for the submitted authentication certificate has previously been identified and a source computer associated with the unique identifier is in the baseline profile.

In an embodiment, the baseline profile is generated using machine learning.

In an embodiment, the authentication protocol is Kerberos and the request is a Kerberos Authentication Server (AS) request.

In an embodiment, the authentication protocol is Kerberos and the baseline profile is generated based on parsed Kerberos ticket-granting service (TGS) requests and data indicative of usage of remote desktop connections for a requested computer to a desired computer.

In an embodiment, the baseline profile is generated based on a number of uses of the identified authentication certificates.

In an embodiment, the baseline profile is generated based on monitoring use of the identified authentication certificates in the network during a time window.

In an embodiment, APIs configured to provide key-based authentication using digital certificates are monitored.

In an embodiment, a log of unique identifiers is output.

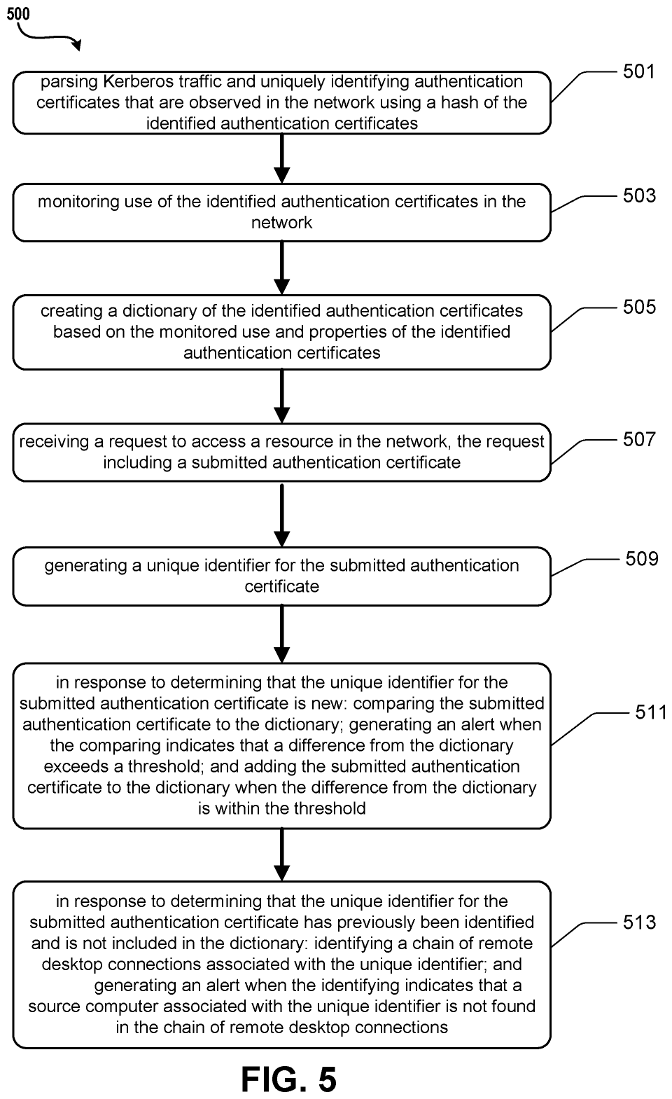

Turning now to FIG. 5, illustrated is an example operational procedure for detecting unauthorized use of credentials in accordance with the present disclosure. The operational procedure may be implemented in a system comprising one or more computing devices. Referring to FIG. 5, operation 501 illustrates parsing Kerberos traffic and uniquely identifying authentication certificates that are observed in the network using a hash of the identified authentication certificates.

Operation 501 may be followed by operation 503. Operation 503 illustrates monitoring use of the identified authentication certificates in the network.

Operation 503 may be followed by operation 505. Operation 505 illustrates creating a dictionary of the identified authentication certificates based on the monitored use and properties of the identified authentication certificates.

Operation 505 may be followed by operation 507. Operation 507 illustrates receiving a request to access a resource in the network, the request including a submitted authentication certificate.

Operation 507 may be followed by operation 509. Operation 509 illustrates generating a unique identifier for the submitted authentication certificate.

Operation 509 may be followed by operation 511. Operation 511 illustrates in response to determining that the unique identifier for the submitted authentication certificate is new, comparing the submitted authentication certificate to the dictionary, generating an alert when the comparing indicates that a difference from the dictionary exceeds a threshold, and adding the submitted authentication certificate to the dictionary when the difference from the baseline profile is within the threshold.

Operation 509 may be followed by operation 511. Operation 511 illustrates in response to determining that the unique identifier for the submitted authentication certificate is new, comparing the submitted authentication certificate to the dictionary, generating an alert when the comparing indicates that a difference from the dictionary exceeds a threshold, and adding the submitted authentication certificate to the dictionary when the difference from the baseline profile is within the threshold.

Operation 511 may be followed by operation 513. Operation 513 illustrates in response to determining that the unique identifier for the submitted authentication certificate has previously been identified and is not included in the dictionary, identifying a chain of remote desktop connections associated with the unique identifier, and generating an alert when the identifying indicates that a source computer associated with the unique identifier is not found in the chain of remote desktop connections.

The various aspects of the disclosure are described herein with regard to certain examples and embodiments, which are intended to illustrate but not to limit the disclosure. It should be appreciated that the subject matter presented herein may be implemented as a computer process, a computer-controlled apparatus, or a computing system or an article of manufacture, such as a computer-readable storage medium. While the subject matter described herein is presented in the general context of program modules that execute on one or more computing devices, those skilled in the art will recognize that other implementations may be performed in combination with other types of program modules. Generally, program modules include routines, programs, components, data structures and other types of structures that perform particular tasks or implement particular abstract data types.

Those skilled in the art will also appreciate that the subject matter described herein may be practiced on or in conjunction with other computer system configurations beyond those described herein, including multiprocessor systems. The embodiments described herein may also be practiced in distributed computing environments, where tasks are performed by remote processing devices that are linked through a communications network. In a distributed computing environment, program modules may be located in both local and remote memory storage devices.

Networks established by or on behalf of a user to provide one or more services (such as various types of cloud-based computing or storage) accessible via the Internet and/or other networks to a distributed set of clients may be referred to as a service provider. Such a network may include one or more data centers such as data center 300 illustrated in FIG. 3, which are configured to host physical and/or virtualized computer servers, storage devices, networking equipment and the like, that may be used to implement and distribute the infrastructure and services offered by the service provider.

In some embodiments, a computing device that implements a portion or all of one or more of the technologies described herein, including the techniques to implement the detection of unauthorized use of user credentials in a network implementing an authentication protocol may include a general-purpose computer system that includes or is configured to access one or more computer-accessible media. FIG. 6 illustrates such a general-purpose computing device 600. In the illustrated embodiment, computing device 600 includes one or more processors 610a, 610b, and/or 610n (which may be referred herein singularly as “a processor 610” or in the plural as “the processors 610”) coupled to a system memory 620 via an input/output (I/O) interface 630. Computing device 600 further includes a network interface 640 coupled to I/O interface 630.

In various embodiments, computing device 600 may be a uniprocessor system including one processor 610 or a multiprocessor system including several processors 610 (e.g., two, four, eight, or another suitable number). Processors 610 may be any suitable processors capable of executing instructions. For example, in various embodiments, processors 610 may be general-purpose or embedded processors implementing any of a variety of instruction set architectures (ISAs), such as the x66, PowerPC, SPARC, or MIPS ISAs, or any other suitable ISA. In multiprocessor systems, each of processors 610 may commonly, but not necessarily, implement the same ISA.

System memory 620 may be configured to store instructions and data accessible by processor(s) 610. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques and data described above, are shown stored within system memory 620 as code 625 and data 626.

In one embodiment, I/O interface 630 may be configured to coordinate I/O traffic between the processor 610, system memory 620, and any peripheral devices in the device, including network interface 640 or other peripheral interfaces. In some embodiments, I/O interface 630 may perform any necessary protocol, timing, or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components. Also, in some embodiments some or all of the functionality of I/O interface 630, such as an interface to system memory 620, may be incorporated directly into processor 610.

Network interface 640 may be configured to allow data to be exchanged between computing device 600 and other device or devices 680 attached to a network or network(s) 650, such as other computer systems or devices as illustrated in FIGS. 1 through 4, for example. In various embodiments, network interface 640 may support communication via any suitable wired or wireless general data networks, such as types of Ethernet networks, for example. Additionally, network interface 640 may support communication via telecommunications/telephony networks such as analog voice networks or digital fiber communications networks, via storage area networks such as Fibre Channel SANs or via any other suitable type of network and/or protocol.

In some embodiments, system memory 620 may be one embodiment of a computer-accessible medium configured to store program instructions and data as described above for FIGS. 1-5 for implementing embodiments of the corresponding methods and apparatus. However, in other embodiments, program instructions and/or data may be received, sent or stored upon different types of computer-accessible media. A computer-accessible medium may include non-transitory storage media or memory media, such as magnetic or optical media, e.g., disk or DVD/CD coupled to computing device 600 via I/O interface 630. A non-transitory computer-accessible storage medium may also include any volatile or non-volatile media, such as RAM (e.g. SDRAM, DDR SDRAM, RDRAM, SRAM, etc.), ROM, etc., that may be included in some embodiments of computing device 600 as system memory 620 or another type of memory. Further, a computer-accessible medium may include transmission media or signals such as electrical, electromagnetic or digital signals, conveyed via a communication medium such as a network and/or a wireless link, such as may be implemented via network interface 640. Portions or all of multiple computing devices, such as those illustrated in FIG. 6, may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices and is not limited to these types of devices.

Various storage devices and their associated computer-readable media provide non-volatile storage for the computing devices described herein. Computer-readable media as discussed herein may refer to a mass storage device, such as a solid-state drive, a hard disk or CD-ROM drive. However, it should be appreciated by those skilled in the art that computer-readable media can be any available computer storage media that can be accessed by a computing device.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing devices discussed herein. For purposes of the claims, the phrase “computer storage medium,” “computer-readable storage medium” and variations thereof, does not include waves, signals, and/or other transitory and/or intangible communication media, per se.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the disclosed computing devices in order to store and execute the software components and/or functionality presented herein. It is also contemplated that the disclosed computing devices may not include all of the illustrated components shown in FIG. 6, may include other components that are not explicitly shown in FIG. 6, or may utilize an architecture completely different than that shown in FIG. 6.

Although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated any reference to “first,” “second,” etc. items and/or abstract concepts within the description is not intended to and should not be construed to necessarily correspond to any reference of “first,” “second,” etc. elements of the claims. In particular, within this Summary and/or the following Detailed Description, items and/or abstract concepts such as, for example, individual computing devices and/or operational states of the computing cluster may be distinguished by numerical designations without such designations corresponding to the claims or even other paragraphs of the Summary and/or Detailed Description. For example, any designation of a “first operational state” and “second operational state” of the computing cluster within a paragraph of this disclosure is used solely to distinguish two different operational states of the computing cluster within that specific paragraph—not any other paragraph and particularly not the claims.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method for detecting unauthorized use of user credentials in a network implementing an authentication protocol, the method comprising:
uniquely identifying authentication certificates that are observed in the network;
monitoring use of the identified authentication certificates in the network;
determining a baseline profile of the identified authentication certificates based on the monitored use and properties of the identified authentication certificates;
accessing a request to access a resource in the network, the request including a submitted authentication certificate;
generating a unique identifier for the submitted authentication certificate;
in response to determining that the unique identifier for the submitted authentication certificate is new:
comparing the submitted authentication certificate to the baseline profile;
generating an alert when the comparing indicates that a difference from the baseline profile exceeds a threshold; and
adding the submitted authentication certificate to the baseline profile when the difference from the baseline profile is within the threshold;
in response to determining that the unique identifier for the submitted authentication certificate has previously been identified and is not included in the baseline profile:
identifying a chain of connections associated with the unique identifier; and
generating an alert when the identifying indicates that a source computer associated with the unique identifier is not found in the chain of connections.

2. The method of claim 1, wherein the authentication protocol is Kerberos.

3. The method of claim 1, wherein the method is performed by an application or agent running in a domain controller of the network.

4. The method of claim 1, wherein the unique identifiers are generated based on a hash of the certificates.

5. The method of claim 1, wherein the properties comprise one or more of a signature algorithm, a signature hash algorithm, a time period during which the certificate is valid, a public key size, a subject format, and certificate templates.

6. The method of claim 1, further comprising continuing to monitor the network when the unique identifier for the submitted authentication certificate has previously been identified and a source computer associated with the unique identifier is in the baseline profile.

7. A computing device configured to detect unauthorized use of user credentials in a network implementing an authentication protocol, the computing device comprising:
a processor;
a storage device coupled to the processor;
an application stored in the storage device, wherein execution of the application by the processor configures the computing device to perform acts comprising:
uniquely identifying authentication certificates that are observed in the network;
monitoring use of the identified authentication certificates in the network;
determining a baseline profile of the identified authentication certificates based on the monitored use and properties of the identified authentication certificates;
accessing a request to access a resource in the network, the request including a submitted authentication certificate;
generating a unique identifier for the submitted authentication certificate;
in response to determining that the unique identifier for the submitted authentication certificate is new:
comparing the submitted authentication certificate to the baseline profile;
generating an alert when the comparing indicates that a difference from the baseline profile exceeds a threshold; and
adding the submitted authentication certificate to the baseline profile when the difference from the baseline profile is within the threshold;
in response to determining that the unique identifier for the submitted authentication certificate has previously been identified and is not included in the baseline profile:
identifying a chain of connections associated with the unique identifier; and
generating an alert when the identifying indicates that a source computer associated with the unique identifier is not found in the chain of connections.

8. The computing device of claim 7, wherein the baseline profile is generated using machine learning.

9. The computing device of claim 7, wherein the authentication protocol is Kerberos and the request is a Kerberos Authentication Server (AS) request.

10. The computing device of claim 7, wherein the authentication protocol is Kerberos and the baseline profile is generated based on parsed Kerberos ticket-granting service (TGS) requests and data indicative of usage of remote desktop connections for a requested computer to a desired computer.

11. The computing device of claim 7, wherein the baseline profile is generated based on a number of uses of the identified authentication certificates.

12. The computing device of claim 7, wherein the baseline profile is generated based on monitoring use of the identified authentication certificates in the network during a time window.

13. A computer-readable medium having stored thereon a plurality of sequences of instructions which, when executed by a processor, cause the processor to perform a method comprising:
uniquely identifying authentication certificates that are observed in a network implementing an authentication protocol;
monitoring use of the identified authentication certificates in the network;
determining a baseline profile of the identified authentication certificates based on the monitored use and properties of the identified authentication certificates;
accessing a request to access a resource in the network, the request including a submitted authentication certificate;
generating a unique identifier for the submitted authentication certificate;
in response to determining that the unique identifier for the submitted authentication certificate is new:
comparing the submitted authentication certificate to the baseline profile;
generating an alert when the comparing indicates that a difference from the baseline profile exceeds a threshold; and
adding the submitted authentication certificate to the baseline profile when the difference from the baseline profile is within the threshold;
in response to determining that the unique identifier for the submitted authentication certificate has previously been identified and is not included in the baseline profile:
identifying a chain of connections associated with the unique identifier; and
generating an alert when the identifying indicates that a source computer associated with the unique identifier is not found in the chain of connections.

14. The computer-readable medium of claim 13, further comprising instructions which, when executed by the processor, cause the processor to monitor APIs configured to provide key-based authentication using digital certificates.

15. The computer-readable medium of claim 14, further comprising instructions which, when executed by the processor, cause the processor to output a log of unique identifiers.

16. The computer-readable medium of claim 13, wherein the unique identifiers are generated based on a hash of the certificates.

17. The computer-readable medium of claim 13, wherein the properties comprise one or more of a signature algorithm, a signature hash algorithm, a time period during which the certificate is valid, a public key size, a subject format, and certificate templates.

18. The computer-readable medium of claim 13, further comprising instructions which, when executed by the processor, cause the processor to monitor the network when the unique identifier for the submitted authentication certificate has previously been identified and a source computer associated with the unique identifier is in the baseline profile.

19. The computer-readable medium of claim 13, wherein the authentication protocol is Kerberos and the request is a Kerberos Authentication Server (AS) request.

20. The computer-readable medium of claim 13, wherein the authentication protocol is Kerberos and the baseline profile is generated based on parsed Kerberos ticket-granting service (TGS) requests and data indicative of usage of remote desktop connections for a requested computer to a desired computer.
